(19) United States
(12) Patent Application Publication
(10) Pub. No.: US 2025/0232374 A1
(43) Pub. Date: Jul. 17, 2025

(54) ANALYTICS FOR DYNAMIC INDUSTRY CASH FLOW MODELING

(71) Applicant: Wells Fargo Bank, N.A., San Francisco, CA (US)

(72) Inventors: Phani Raj Gattu, Hyderabad (IN); Ramprabhu Thirukandalam Kadambi, Chennai (IN)

(21) Appl. No.: 18/410,684

(22) Filed: Jan. 11, 2024

(51) Int. Cl. G06Q 40/06

(52) U.S. Cl. CPC G06Q 40/06

(57) ABSTRACT

A financial analytics platform for analyzing the impact of macroeconomic fluctuations on the interdependencies among various industries, involving collecting detailed payment transaction data from a diverse group of banking clients and categorizing each transaction by the industry classifications of both the sender and receiver, the transaction amount, and timing. This data is then aggregated according to industry, enabling the identification and quantification of dependencies between multiple industries based on the total transaction values over time. An interactive network is constructed to present these dependencies, where industries are represented as nodes and their interconnections as links, which vary in characteristics to illustrate a strength of inter-industry relationships. Additionally, the platform incorporates a dynamic time element, enabling users to observe and analyze how these inter-industry dependencies evolve and respond to macroeconomic changes, offering valuable insights for strategic financial planning and risk management.

### BACKGROUND

The impact of key macroeconomic factors, such as interest rates, exchange rates, inflation, and gross domestic product (GDP), on business operations is well acknowledged. However, there is a notable deficiency in the understanding and application of how these broad economic indicators interact and affect the specific conditions unique to each industry. This gap is further widened when considering microeconomic elements like variations in raw material costs, labor expenses, technological changes, and fluctuations in product demand, which are often regional or sub-industry-specific.

These factors are intricate and require sophisticated calibration for accurate integration into a company's overall health assessment. Moreover, the lack of advanced tools capable of simulating the potential effects of historical economic events under new or altered conditions poses a significant challenge, restricting a business's ability to foresee, prepare, and strategically plan for future market dynamics and economic shifts, thereby impeding effective decision-making in an evolving economic environment.

### SUMMARY

Embodiments of the disclosure are directed to acquiring payment transaction data from a plurality of banking customers, wherein each transaction of the payment transaction data includes an industry classification of the originating party, an industry classification of the receiving party, an amount of the payment transaction, and a timing of the payment transaction, aggregating the payment transaction data by industry to establish dependencies between two or more industries, wherein the dependencies are based on an aggregated amount of the payment transactions occurring between the two or more industries over a period of time, establishing a network to represent the dependencies between the two or more industries, wherein each industry is denoted as a node in the network, and the dependencies between the nodes are denoted as links, with a characteristic of each link indicating a strength of the dependencies between the two or more industries, and adding a temporal element, enabling a customer to observe of a relative change in the strength of the dependencies between the two or more industries relative to fluctuation of a macroeconomic factor.

Embodiments also encompass a computer system for providing tailored, business-specific reporting based on anticipated reporting needs of a business in commercial banking. The computer system is equipped with one or more processors and non-transitory computer-readable storage media which, when executed by the one or more processors, cause the computer system to acquire payment transaction data from a plurality of banking customers, wherein each transaction of the payment transaction data includes an industry classification of the originating party, an industry classification of the receiving party, an amount of the payment transaction, and a timing of the payment transaction, aggregate the payment transaction data by industry to establish dependencies between two or more industries, wherein the dependencies are based on an aggregated amount of the payment transactions occurring between the two or more industries over a period of time, establish a network to represent the dependencies between the two or more industries, wherein each industry is denoted as a node in the network, and the dependencies between the nodes are denoted as links, with a characteristic of each link indicating a strength of the dependencies between the two or more industries, and add a temporal element to the industry, enabling a customer to observe of a relative change in the strength of the dependencies between the two or more industries relative to fluctuation of a macroeconomic factor.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example of a financial analytics system for forecasting an impact of macroeconomic factor fluctuations on interdependencies among industries.

FIG. 2 shows an example server device of the computer system of FIG. 1.

FIG. 3 shows example modules of a data acquisition engine of the server device of FIG. 2.

FIG. 4 shows example modules of an aggregation engine of the server device of FIG. 2.

FIG. 5 shows example modules of a network modeling engine of the server device of FIG. 2.

FIG. 6 shows a transaction-based connection model between a customer and a plurality of entities organized into industries for display on the user interface of FIG. 1.

FIG. 7 shows a network model depicting a strength of dependencies between a customer and one or more industries for display on the user interface of FIG. 1.

FIG. 8 shows example physical components of the server device of FIG. 2.

### DETAILED DESCRIPTION

This disclosure relates to forecasting an impact of a change in a macroeconomic factor on interdependencies among industries, implemented by a financial analytics system.

This disclosure introduces a financial analytics system that employs advanced data acquisition and aggregation methods to collect and compile payment transaction data from a multitude of banking customers. The system categorizes each transaction by industry, using standardized industry classifications, and aggregates this data to reveal and analyze the dependencies between different industries. This comprehensive approach allows for a more nuanced understanding of economic dynamics and the interconnected nature of different sectors.

The financial analytics system comprises one or more processors and non-transitory computer-readable storage media encoding instructions. These instructions enable the system to process large volumes of transaction data, apply statistical and machine learning techniques to identify patterns and anomalies, and generate visual representations of industry networks. The system's processors are configured to execute complex algorithms that discern the strength and nature of dependencies between industries and track how these relationships evolve over time.

Additionally, the financial analytics system includes a network modeling engine that constructs a detailed network map of industry interdependencies. Each industry is represented as a node in the network, and the transactions between industries are visualized as links. The visual characteristics of these links, such as thickness or color, indicate the strength and significance of the dependencies. The system also incorporates a temporal analysis feature, allowing users to observe how these inter-industry relationships change in response to external economic events and trends.

Moreover, the financial analytics system features a simulation module capable of modeling the potential impact of historical and hypothetical macroeconomic events on industry dependencies. This module enables businesses and financial analysts to conduct scenario analyses and stress tests, assessing how different economic conditions might affect industry dynamics and their own business operations. The system also includes a predictive analytics feature that projects future industry trends and evaluates the potential risks and opportunities for companies within these interconnected economic networks.

This concept transcends mere abstraction through its integration of a user interface that includes active links and graphical representations of macroeconomic events, elements that cannot feasibly be replicated or processed within the human mind. The complexity and volume of the data involved, encompassing a myriad of transactions across various industries, necessitate a sophisticated computational approach. Furthermore, the financial analytics system is not just a passive aggregator of data; it is empowered by trained artificial intelligence (AI) algorithms that actively interpret and analyze this data. These AI algorithms enable the system to discern patterns, predict future industry trends, and simulate the potential impacts of macroeconomic events, thereby transforming the raw data into actionable insights. This practical application of AI, combined with an interactive and dynamic user interface, clearly demonstrates the concept's utility beyond theoretical or abstract ideas, firmly grounding it in the realm of tangible, advanced technological solutions.

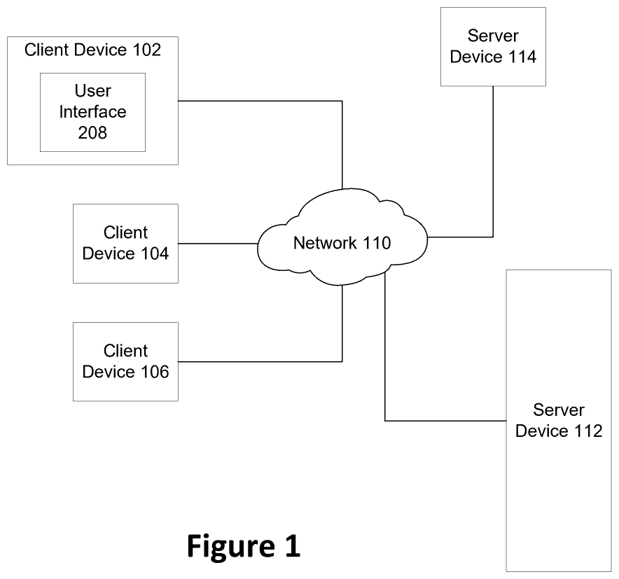

FIG. 1 provides a schematic representation of a financial analytics system 100 designed for forecasting an impact of macroeconomic fluctuations on interdependencies among industries. Although certain embodiments highlight the analysis of data pertinent to online banking and financial systems, specifically in the realm of commercial banking, the overarching principles evinced here are versatile, catering to a diverse range of business domains and operational paradigms.

As depicted in FIG. 1, the financial analytics system 100 embodies a computing environment including one or more client devices 102, 104, 106 connected to a server device 112 and a server device 114, via a network 110. The client devices 102, 104, and 106 are characterized as computing devices equipped with at least one processor and memory. These client devices 102, 104, 106 cater to the needs of business personnel and customers, facilitating various banking and online financial transactions. Exemplifying versatility, these client devices 102, 104, 106 may encompass mobile computing devices, on-premise apparatus, data sources, or other hardware capable of interfacing with network 110 components.

The network 110 functions as the underlying communication framework, ensuring seamless data exchange and interaction between the client devices 102, 104, 106 and one or more server devices 112, 114. Server device 112 can embody a substantial computing infrastructure, akin to a server farm, and serves as the core entity within this environment. Server device 114 can be loaded with one or more engines or modules configured to aid building a model to identify interdependencies among industries, as well as to forecast and impact of macroeconomic fluctuations on an industry or individual entity within an industry.

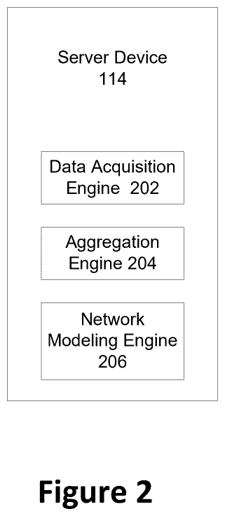

As further depicted in FIG. 2, the server device 114 can comprise one or more engines, with each engine configured as a specialized component adapted to perform specific computational processing tasks within the financial analytics system 100. For example, in some embodiments, the server device 114 can include a data acquisition engine 202, data aggregation engine 204, and network modeling engine 206.

The data acquisition engine 202 can be adapted to perform a number of functions in the realm of data collection and initial processing within the financial analytics system 100. The data acquisition engine 202 can be specifically tasked with the systematic gathering of payment transaction data from various banking customers, which can involve capturing comprehensive transaction details, which can include the industry classification of both the originating and receiving parties, the amount of each transaction, and the precise timing of these transactions. The data acquisition engine 202 can be adapted to handle large volumes of data, ensuring accuracy and consistency in the information collected.

The data acquisition engine 202 can serve as the foundational layer of the financial analytics system 100, providing the raw data essential for further processing and analysis by other components within the server device, such as the data aggregation engine 204 and the network modeling engine 206. Through its sophisticated data collection methodologies, the data acquisition engine 202 can establish the basis for the subsequent analytical capabilities of the financial analytics system 100.

The data acquisition engine 202 can be configured with features that ensure data privacy and security, particularly in the context of commercial banking transactions. The data acquisition engine 202 can integrate advanced encryption protocols to protect transaction data at every stage, from collection to storage and processing. The encryption can safeguard the data against unauthorized access and potential security breaches.

In alignment with the requirements of commercial banking, the data acquisition engine 202 can also be equipped to handle compliance reporting needs. The data acquisition engine 202 can maintain accurate transaction records, consistent with regulatory standards, and ensures that data management processes adhere to relevant financial regulations and privacy laws. In embodiments, updates can be made to the data acquisition engine 202 to keep pace with changes in legal and industry standards, thereby sustaining compliance with established legal frameworks of commercial banking operations.

The data aggregation engine 204, as a part of the server device 114, can be responsible for the consolidation and organization of the transaction data collected by the data acquisition engine 202. The data aggregation engine 204 can be configured to group this data by various industry classifications, a process that enables the identification of patterns and relationships within and across different sectors. The data aggregation engine 204 can process the data to establish a clear understanding of the dependencies between industries, based on the aggregated transaction values and frequencies over specified time periods. This organized and aggregated data can become the basis for deeper analysis and insight generation, which can then be utilized by other components of the system, such as the network modeling engine 206, for further specialized processing and modeling tasks.

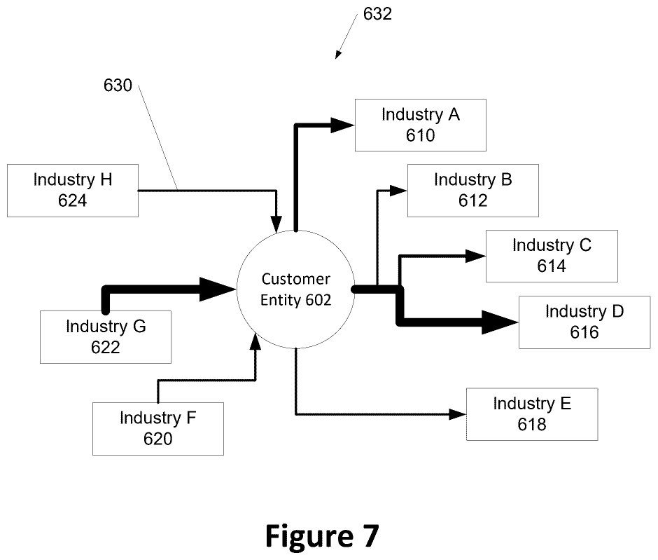

The network modeling engine 206, a component of the server device 114, can be tasked with creating a visual representation of the interdependencies between different industries. Utilizing the aggregated transaction data processed by the data aggregation engine 204, the network modeling engine 206 can construct a network model (as depicted in FIG. 7). In this map, each industry can be represented as a node, and the connections between these nodes, indicative of the transactional relationships between industries, can be depicted as links. The characteristics of these links, such as their thickness or color, can be designed to represent the strength and nature of the dependencies between the industries.

Additionally, the network modeling engine 206 can incorporate a temporal element into the network, allowing users to observe and analyze how the inter-industry relationships change over time, particularly in response to the fluctuation of one or more macroeconomic indicators over the time span of a financial event. This dynamic representation can aid in the comprehensive understanding and analysis of industry trends and economic influences.

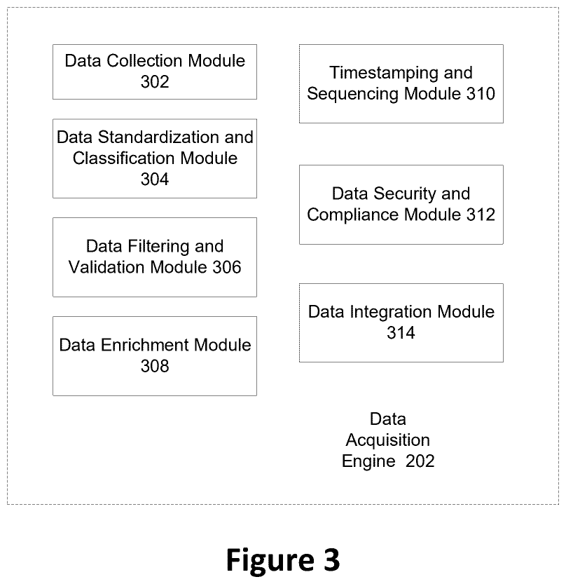

With additional reference to FIG. 3, a block diagram depicting the data acquisition engine 202 of FIG. 2 is depicted. In some embodiments, the data acquisition engine 202 can include a data collection module 302 (configured to communicate with server device 112), data standardization and classification module 304, data filtering and validation module 306, data enrichment module 308, timestamping and sequencing module 310, data security and compliance module 312, and data integration module 314, with each of these modules programmed to perform one or more computational functions.

The data collection module 302, a constituent of the data acquisition engine, can be tasked with the function of gathering payment transaction data from a broad spectrum of banking customers. In some embodiments, the data collection module 302 module can act as the initial point of contact with the server device 112, facilitating the communication and transfer of transaction data to the analytics system.

Functionally, the data collection module 302 can be programmed to efficiently and accurately retrieve comprehensive transaction details from various banking systems. This can include capturing key data elements of each transaction, such as the industry classification of both the originating and the receiving parties, the monetary amount of the transaction, and the precise timing when the transaction occurred.

To achieve this, the data collection module 302 can utilize several methods of data retrieval, such as API calls to banking systems, direct database access, or batch processing of transaction records. The data collection module 302 can be equipped to handle large volumes of data, ensuring that the data collection process is robust, scalable, and capable of managing the extensive transaction data inflow from numerous banking customers.

Moreover, the data collection module 302 can be designed to work can be real-time or near-real-time, enabling the system 100 to process the most current transaction data. The data collection module 302 can serve as the foundation for the subsequent stages of data processing within the data acquisition engine 202, setting the stage for more advanced operations like standardization, classification, and analysis of the transaction data.

The data standardization and classification module 304, as part of the data acquisition engine 202 can have a specific set of functionalities centered around ensuring the uniformity and proper categorization of the acquired transaction data. Functionally, the data acquisition engine 202 can address two key aspects: data standardization and data classification.

Given the diverse sources of transaction data, a first aspect of the data acquisition engine 202 is to standardize the incoming data into a consistent format. This process can involve converting various data formats, structures, and representations into a uniform format that is compatible with the requirements of the financial analytics system 100. Standardization enable accurate analysis and comparison of data across different entities and transactions, and to ensure that subsequent processing, like aggregation or analysis, is based on reliable and consistent data inputs.

A second aspect of the data acquisition engine 202 is the classification of transaction data based on industry categories. Each transaction can be categorized according to the industry classification of both the originating party (sender) and the receiving party. The data acquisition engine 202 can use predefined industry classification systems, such as the North American Industry Classification System (NAICS) or the Standard Industrial Classification (SIC) system, to categorize each transaction to accurately identify and analyze industry-specific trends, dependencies, and patterns.

The data standardization and classification module 304 operates on the raw transaction data collected by the data collection module 302. By transforming this data into a standardized and appropriately classified form, the data standardization and classification module 304 can prepare the transaction data for more advanced stages of processing and analysis within the financial analytics system 100, such as aggregation, filtering, and enrichment. The data standardization and classification module 304 module aids in maintaining the integrity and usefulness of the transaction data, ensuring that the insights derived from the analytics system are based on accurate and properly categorized data.

The data filtering and validation module 306 can be responsible for refining and assuring the quality of the payment transaction data collected from various banking customers. The data filtering function can involve sifting through the collected transaction data to remove irrelevant or unnecessary information. Given the vast amount of data collected, not all of the data may be pertinent to the specific analytical objectives of the system 100. The data filtering and validation module 306 identifies and excludes data that does not meet predefined criteria or relevance thresholds. This process can be important for focusing the analysis on meaningful data, thereby enhancing the efficiency of the system and preventing the cluttering of datasets with extraneous information.

Once the data is filtered, a next step can be to validate the accuracy and completeness of the remaining data. The data validation function can check for errors, inconsistencies, or anomalies in the data, and verifies the accuracy of key data elements such as industry classifications, transaction amounts, and timing details. This process can involve cross-referencing data points with external databases or applying internal consistency checks. Validation can ensure that the data used for subsequent analysis is reliable and credible, useful for maintaining the integrity of the analytics and the insights derived from it.

By efficiently filtering out irrelevant data and rigorously validating the remaining information, the data filtering and validation module 306 can ensure that the subsequent stages of data processing, such as enrichment and integration, are based on a solid foundation of relevant and accurate data.

The data enrichment module 308 within the data acquisition engine 202 can be configured to augment the raw transaction data with additional context and information. Functionalities of the data enrichment module 308 can include augmenting transaction data, contextualizing data, enhancing data for advanced analysis, and data correlation, among others.

Augmenting transaction data can involve adding supplementary information to each transaction record. For instance, beyond the basic data points such as the industry classification of the parties involved, transaction amount, and timing, the data enrichment module 308 can incorporate additional data like geographical location, market segment information, or economic indicators relevant to the parties involved in the transaction.

In some embodiments, the data enrichment module 308 can contextualize each transaction within a broader economic and industry-specific framework. This can involve mapping transaction data against prevailing market trends, economic conditions, or sector-specific developments. By doing so, the data enrichment module 308 can provide a richer, more nuanced understanding of each transaction.

Additionally, by enriching the transaction data, the data enrichment module 308 can prepare the data for more sophisticated forms of analysis, such as predictive modeling, trend analysis, or scenario planning. The enriched data can reveal deeper insights, such as underlying market dynamics, industry trends, or predictive indicators of economic shifts.

The data enrichment module 308 can also correlate transaction data with related datasets, which can include linking transaction patterns to external economic events, policy changes, or market disruptions, thereby providing a more comprehensive view of the factors influencing transaction behaviors.

By augmenting and contextualizing the data, the data enrichment module 308 can transform raw transaction information into a rich dataset ready for complex analysis and interpretation, the data enrichment module 308 can significantly enhance the depth and breadth of the transaction data processed by the financial analytics system.

The timestamping and sequencing module 310 within the data acquisition engine 202 can play a role in organizing the payment transaction data acquired from various banking customers. This timestamping and sequencing module 310 can be designed to assign accurate time stamps to each transaction and sequence them in an orderly manner, enhancing the temporal coherence and integrity of the data set. Functionalities of the timestamping and sequencing module 310 can include accurate time stamping, consistent sequencing, temp oral data integrity, and facilitating time-based analysis.

One function of the timestamping and sequencing module 310 is to assign a precise timestamp to each transaction. This timestamp can record the exact date and time when the transaction occurred. Accurate timestamping is useful for chronological analysis and tracking the sequence of transactions over time. It ensures that each transaction can be contextualized within a specific temporal framework, which is important for time-sensitive analyses such as trend tracking or identifying time-based patterns.

Beyond just timestamping, the timestamping and sequencing module 310 can also sequence the transactions in the order which they occurred. This sequencing is important for maintaining the chronological integrity of the transaction data. Proper sequencing allows for the analysis of transaction flows and patterns over time, enabling the system to track developments and changes in transaction behavior.

Additionally, the timestamping and sequencing module 310 can ensure the temporal data integrity of the transaction records. Specifically, the timestamping and sequencing module 310 can check for any discrepancies in timestamps and corrects anomalies such as out-of-sequence transactions. This process maintains the reliability of the data, particularly for time-series analyses.

By providing accurate timestamps and sequencing, the timestamping and sequencing module 310 can facilitate various time-based analyses within the financial analytics system. These analyses can include assessing the impact of specific events on transaction patterns, studying seasonal trends, or evaluating the timing of transactions in relation to market or economic indicators.

The data security and compliance module 312 within the data acquisition engine 202 can be configured to ensure the security and regulatory compliance of the payment transaction data acquired from banking customers. Functionality of the data security and compliance module 312 can include implementing data security protocols, regulatory compliance assurance, monitoring and auditing, data privacy management, and incident response and reporting.

In some embodiments, the data security and compliance module 312 can be responsible for enforcing robust security measures to protect the transaction data from unauthorized access, breaches, or other cyber threats. This can include implementing encryption techniques to secure data during transmission and storage, setting up firewalls, and using secure protocols for data communication.

The data security and compliance module 312 can ensure that all data acquisition, processing, and storage practices comply with relevant financial industry regulations and data protection laws. This can involve adhering to standards such as the Payment Card Industry Data Security Standard (PCI DSS), General Data Protection Regulation (GDPR), and other regional or sector-specific regulations.

The data security and compliance module 312 can monitor the data acquisition system for any security vulnerabilities or compliance breaches. The data security and compliance module 312 can also conduct regular audits to assess the effectiveness of the security measures in place and ensures ongoing compliance with regulatory standards.

The data privacy management function can involve managing the privacy of customer data in accordance with legal requirements. The data security and compliance module 312 can implement policies and procedures for data anonymization, access control, and customer consent management, ensuring that customer data is handled ethically and legally.

In case of a data breach or security incident, the data security and compliance module 312 can be equipped to respond promptly. It can include mechanisms for incident detection, response planning, and notification procedures as required by law. The data security and compliance module 312 can also facilitate the generation of compliance reports and documentation needed for regulatory submissions and audits.

The data integration module 314 within the data acquisition engine 202 can be configured to consolidate and synchronize the transaction data processed through the various preceding modules, preparing it for comprehensive analysis and reporting within the financial analytics system. Functions of the data integration module 314 can include consolidating processed data, ensuring data cohesion and compatibility, facilitating data flow to analytical tools, data synchronization, and supporting data quality and integrity.

The data integration module 314 can play a role in aggregating the transaction data that has been collected, standardized, filtered, validated, enriched, timestamped, and secured by the other modules, to ensure that all these disparate pieces of data are brought together in a cohesive and organized manner.

The data integration module 314 can ensure that the data from various sources and processes is compatible and coherent. In particular, the data integration module 314 can harmonize different data formats, structures, and schemas to create a unified dataset that can be seamlessly used across the financial analytics system.

The integrated data can then be channeled to various analytical tools and components of the system 100. The data integration module 314 can ensure a smooth and efficient flow of data, feeding the integrated dataset into tools for advanced analysis, such as predictive modeling, network analysis, and reporting.

In environments where data is continuously being updated, the data integration module 314 can maintain synchronization across all datasets. The data integration module 314 can manage real-time or near-real-time data updates, ensuring that the most current data is available for analysis.

By overseeing the final amalgamation of data from multiple sources and processes, the data integration module 314 can support the overall quality and integrity of the data. The data integration module 314 plays a role in ensuring that the final dataset is complete, accurate, and ready for high-level analysis and decision-making processes.

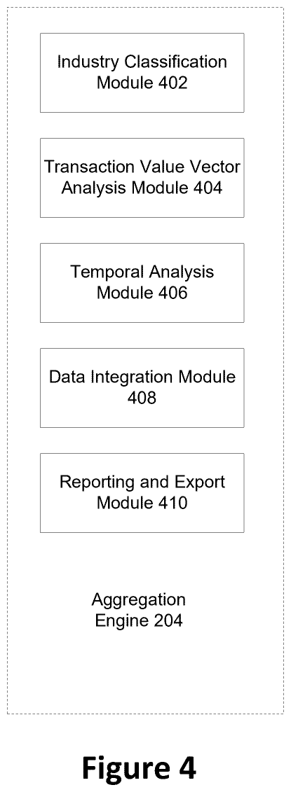

With additional reference to FIG. 4, a block diagram depicting the data aggregation engine 204 of FIG. 2 is depicted. In some embodiments, the data aggregation engine 204 can include an industrial classification module 402, a transaction value analysis module 404, temporal analysis module 406, data integration module 408, and reporting export module 410, with each of these modules programmed to perform one or more computational functions.

The industrial classification module 402 within the data aggregation engine 204 can play a role in the process of organizing and analyzing payment transaction data in relation to specific industries. The industrial classification module 402 enables the effective categorization of transactions, for establishing and understanding industry dependencies. Important functions of the industrial classification module 402 include categorizing transactions by industry, ensuring accuracy and consistency, facilitating sector specific analysis, supporting aggregation and dependency analysis, and adapting to industry changes.

In embodiments, one function of the industrial classification module 402 is to assign an appropriate industry classification to each transaction based on the nature of the originating and receiving parties. This can involve analyzing the characteristics of each transaction and matching them to predefined industry categories, typically using established classification systems like the NAICS or SIC.

Additionally, the industrial classification module 402 can be responsible for maintaining accuracy and consistency in the classification process, for ensuring that the subsequent aggregation and analysis of transaction data are based on reliable and uniform categorizations.

By categorizing transactions into specific industries, the industrial classification module 402 can enable the system to perform sector-specific analyses, to allow for a more nuanced understanding of transaction patterns and dependencies within and across different sectors of the economy.

The accurate classification of transactions by industry is important for the effective aggregation of this data. The industrial classification module 402 supports the process of compiling transaction data by industry for analyzing the volume and value of transactions within each sector and understanding the dependencies between different industries. Additionally, the industrial classification module 402 can be capable of adapting to changes in industry definitions and classifications, ensuring that the categorization process remains relevant and up-to-date with the latest industry standards and trends.

The transaction value analysis module 404, within the data aggregation engine 204 can dissect and interpret the financial aspects of payment transactions between industries. The transaction value analysis module 404 can play a role in understanding the monetary dynamics that underline industry interdependencies. Functions of the transaction value analysis module 404 can include dual record keeping, analyzing transaction values, identifying financial dependencies, multidimensional financial analysis, and enhancing financial modeling and forecasting.

One feature of the transaction value analysis module 404 is the use of a dual record-keeping approach for each transaction. In this system 100, a payment transaction is assigned a negative value for the originating party, indicating an outflow of funds, and a corresponding positive value for the receiving party, denoting an inflow. This method allows for a clear and balanced representation of transaction values within the financial network.

The transaction value analysis module 404 is largely focused on analyzing the monetary values of transactions. The transaction value analysis module 404 examines the amounts transferred in each transaction, facilitating an understanding of the financial weight and significance of transactions between different industries.

By assessing the transaction values, the transaction value analysis module 404 aids in identifying which industries are major recipients or providers of funds. This analysis is important for determining the financial dependencies that exist between industries.

The transaction value analysis module 404 allows for a multifaceted financial analysis, considering various aspects of transactions such as amounts, frequency, and the involved industries. This comprehensive approach provides a deeper insight into the financial interactions and dependencies across the industry spectrum.

The data processed by the transaction value analysis module 404 can be important for advanced financial modeling and forecasting. Understanding the transaction values in detail enables the system to predict trends, assess risks, and make informed decisions regarding industry dynamics.

The data integration module 408 in the data aggregation engine 204 can serve the role of synthesizing and harmonizing data processed by various components within the engine. The data integration module 408 module serves to consolidate the disparate data streams into a cohesive, unified format, ensuring seamless interaction and analysis across the system. Functions of the data integration module 408 can include harmonizing data from multiple modules, creating a consolidated database, ensuring data consistency and accuracy, facilitating cross module data flow, and preparing data for analysis and reporting.

The data integration module 408 can integrate data from the industrial classification module 402, transaction value analysis module 404, and temporal analysis module 406. The data integration module 408 can ensure that the data from these different sources is compatible and consistent, facilitating a unified view of transactional relationships and dependencies.

The data integration module 408 can compile and organize the aggregated data into a centralized database. This consolidation is important for enabling efficient access and retrieval of information for advanced analysis and reporting purposes.

The data integration module 408 can play a role in maintaining the consistency and accuracy of the data across the system. The data integration module 408 can resolve any discrepancies or conflicts that might arise from the aggregation and classification processes, ensuring the integrity of the data.

The data integration module 408 can ensure a smooth flow of data between the different components of the data aggregation engine 204. The data integration module 408 can manage data dependencies and hierarchies, ensuring that data is transmitted and received correctly by each module.

The integrated data can be prepped for further analysis and for generating reports. data integration module 408 formats the data in such a way that it is ready for use by analytical tools and the reporting export module 410, enabling the generation of insightful reports and visualizations.

The reporting export module 410 in the data aggregation engine 204 can be designed to transform the aggregated and analyzed payment transaction data into accessible and informative reports. The reporting export module 410 can play a role in presenting the data in a format that is easy to understand and use for decision-making and strategic planning. Functions of the reporting export module 410 include generating insightful reports, customizing reporting, data visualization, export functionality, automated reporting, and integration with external systems.

One function of the reporting export module 410 can be to create comprehensive reports that summarize the findings from the aggregated data. These reports can highlight key insights into industry dependencies, transactional trends, and other significant patterns identified through the analysis.

In some embodiments, the reporting export module 410 can offer customizable reporting options, allowing users to tailor reports based on specific criteria, such as particular industries, time periods, or transaction types. This flexibility ensures that the reports are relevant and meet the diverse needs of different users.

The reporting export module 410 can incorporate data visualization tools to create charts, graphs, and other graphical representations of the data. These visualizations can make complex data more accessible and easier to interpret, facilitating a quicker and deeper understanding of the underlying trends and relationships.

The reporting export module 410 can be equipped with functionality to export reports in various formats (such as PDF, Excel, or CSV files), making it easy to share and distribute the insights with relevant stakeholders. This feature can enable the dissemination of information across different departments or to external parties.

The reporting export module 410 can also automate the generation of reports at scheduled intervals. This automation ensures that stakeholders receive timely updates on industry trends and dependencies, enabling them to make informed decisions based on the latest data.

The reporting export module 410 can be capable of integrating with external systems or platforms, enabling the seamless transfer of reports and insights to other business intelligence tools or decision-making platforms used within the organization.

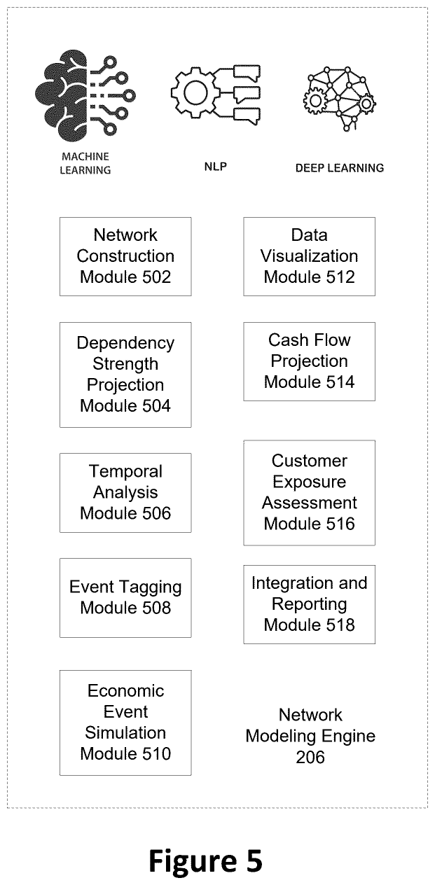

With additional reference to FIG. 5, a block diagram depicting the network modeling engine 206 of FIG. 2 is depicted. In some embodiments, the network modeling engine 206 can include a network construction module 502, dependency strength projection module 504, temporal analysis module 506, event tagging module 508, economic event simulation module 510, data visualization module 512, cash flow projection module 514, customer exposure assessment module 516, and integrated reporting module 518, with each of these modules programmed to perform one or more computational functions.

The network construction module 502 within the network modeling engine 206 can lay the foundational framework for visualizing the complex interdependencies between industries. The network construction module 502 can create a structured network representation where each industry is denoted as a node and the connections (or dependencies) between these nodes are represented as links. Functions of the network construction module 502 include creating industry nodes, establishing links between nodes, assigning characteristics to the lengths, constructing a dynamic network, laying groundwork for further analysis, and facilitating multidimensional analysis.

In embodiments, the network construction module 502 can identify each industry involved in the transaction data and represent them as distinct nodes within the network. These nodes can serve as the fundamental elements of the network, symbolizing the different sectors or industries in the data set. The network construction module 502 can then establish links between these nodes to represent the dependencies between industries which can be derived from the aggregated transaction data, where transactions between industries indicate financial relationships. Each link in the network can be assigned characteristics that generally indicates the strength or other nature of the dependencies between industries. These characteristics can include aspects like the volume of transactions, the value of transactions, the frequency of interactions between industries or other characteristics.

In some embodiments, the network construction module 502 can be capable of creating a dynamic network that can evolve over time, allowing the representation of changes in industry dependencies as new transaction data is processed, providing an up-to-date view of the industry landscape.

The constructed network can serve as the groundwork for further in-depth analysis by other modules in the network modeling engine 206. The constructed network can provide the structural basis for analyzing how industries interact and how these interactions are influenced by various factors. Beyond mere visualization of industry relationships, the network constructed by this module allows for a multidimensional analysis of industry dependencies, taking into account various aspects of the economic relationships and interactions among different sectors.

The dependency strength projection module 504 within the network modeling engine 206 can specialize in assessing and forecasting the strength of financial dependencies between different industries represented in the network. In particular, the dependency strength projection module 504 can play a role in quantitatively analyzing and predicting the dynamics of industry interrelations. Functions of the dependency strength projection module 504 can include, analyzing dependency strengths, forecasting dependency changes, incorporating external factors, dynamic modeling, risk assessment and scenario analysis, and assisting strategic decision-making.

The dependency strength projection module 504 can evaluate the current strength of dependencies between industries, as represented by the links in the network model. The dependency strength projection module 504 can use the characteristics of these links—such as transaction volumes, values, and frequency—to quantify how strongly one industry depends on another.

One function of the dependency strength projection module 504 can be to project how the strength of these dependencies might change over time. The dependency strength projection module 504 can utilize historical data trends and current transaction data to predict future shifts in the financial interdependencies between industries. The dependency strength projection module 504 can also consider external macroeconomic factors that can impact dependency strengths, which can include changes in market conditions, economic policies, or global economic events, ensuring that the projections are comprehensive and realistic.

In embodiments, the dependency strength projection module 504 can be capable of dynamic modeling, allowing the dependency strength projection module 504 to update its projections as new data becomes available to ensure that the dependency forecasts remain relevant and accurate over time.

The dependency strength projection module 504 can contribute to risk assessment by modeling various scenarios and their potential impact on industry dependencies, which can serve as an aid in understanding the resilience of these dependencies under different economic conditions.

By providing insights into the future dynamics of industry dependencies, the dependency strength projection module 504 aids businesses and financial analysts in making informed strategic decisions. The dependency strength projection module 504 helps in identifying potential risks and opportunities in the market landscape.

The temporal analysis module 506 within the network modeling engine 206 can add a dynamic, time-based dimension to the analysis of industry dependencies. The temporal analysis module 506 can serve to enable the examination of how financial relationships and dependencies between industries evolve and fluctuate over time, particularly in response to macroeconomic fluctuations. Functions of the temporal analysis module 506 include time-based data aggregation and analysis, tracking temporal changes in dependency strengths, incorporating macroeconomic fluctuations, enabling predictive temp oral analysis, supporting dynamic reporting and visualization, and assisting in scenario analysis.

In embodiments, the temporal analysis module 506 can aggregate the transaction data over different time periods—such as daily, monthly, quarterly, or annually—and analyze the changes in industry dependencies across these timescales, which can be useful for observing trends, seasonal patterns, and long-term shifts in industry interactions.

The temporal analysis module 506 can examine how the strength of the dependencies between industries changes over time. The temporal analysis module 506 can track the increase or decrease in transaction volumes and values between industries across different time periods, providing insights into the evolving nature of these financial relationships.

One aspect of the temporal analysis module 506 is its ability to factor in macroeconomic fluctuations and events when analyzing temporal data. The temporal analysis module 506 can assess how external economic factors, such as market downturns, policy changes, or global events, impact the financial dependencies between industries over time.

The temporal analysis module 506 can also supports predictive analysis by using historical temporal patterns to forecast future changes in industry dependencies, which can be used for strategic planning and risk management.

Additionally, the temporal analysis module 506 can provide data that supports dynamic reporting and visualization of industry dependencies in the network modeling engine 206, which can enable users to visually track how industry relationships have developed historically and how they might evolve in the future. By analyzing temporal trends, the temporal analysis module 506 can aid in conducting scenario analyses to understand the potential impact of various economic conditions on industry dependencies.

The event tagging module 508 within the network modeling engine 206 can play a role in contextualizing the financial transaction data by marking specific periods associated with significant macroeconomic events. The event tagging module 508 can serve to enhance event tagging module 508 to improve the analytical capabilities of the system by enabling a focused examination of how these events influence industry dependencies. Functions of the event tagging module 508 include identification and tagging of macroeconomic events, before and after analysis, temp oral contextualization of data, facilitating targeting analysis, supporting scenario simulation, and enhancing data visualization and reporting.

In some embodiments, event tagging module 508 can be responsible for identifying significant economic events, such as market crashes, policy changes, economic downturns, or geopolitical incidents, and tagging the transaction data associated with these events. This tagging can serve as an aid in isolating the data from specific time periods for detailed analysis.

By tagging transaction data from periods before and after a macroeconomic event, the event tagging module 508 can enable a comparative analysis to observe the effects of these events on industry dependencies. This can aid in understanding how different industries react to and are impacted by significant economic changes.

The event tags can provide a temporal context to the transaction data, making it possible to analyze how industry dependencies evolve in response to external economic factors, for improved understanding of the resilience and adaptability of industries to economic shocks.

Moreover, the tagged data allows for targeted analysis of specific time periods of interest, making the investigation more efficient and focused. Analysts can quickly access and analyze the data surrounding financial events, enhancing the usability for strategic decision-making by the financial analytics system 100.

The event tagging module 508 also supports the economic event simulation module 510 by providing tagged data as reference points for simulating similar events, which can be useful for stress-testing and scenario planning, as it allows for modeling of potential future impacts based on past occurrences.

Tagged events can also enable data visualization and reporting capabilities of the system. The event tagging module 508 can contribute to the creation of dynamic visual representations and reports that clearly illustrate the impact of macroeconomic events on industry dependencies.

The economic event simulation module 510 within the network modeling engine 206 can play a role in forecasting and analyzing the potential impacts of various macroeconomic events on the financial dependencies between industries. The economic event simulation module 510 can aid in not only understanding current industry dynamics but also to anticipating future shifts and challenges. Functions of the economic event simulation module 510 include simulating macroeconomic events, impact analysis of simulated events, scenario-based forecasting, integrating historical data for realism, risk assessment and strategic planning, and interactive simulation features.

In embodiments, the economic event simulation module 510 can be designed to simulate a range of potential economic events, such as recessions, policy shifts, market disruptions, or geopolitical crises. The economic event simulation module 510 can model how these events might unfold and assesses their potential impacts on industry dependencies as represented in the network.

One function of the economic event simulation module 510 is to analyze the effects of these simulated events on the transactional relationships between industries. The economic event simulation module 510 can examine how changes in economic conditions might alter the strength, nature, and dynamics of industry dependencies.

The economic event simulation module 510 can enable scenario-based forecasting, where multiple potential future scenarios can be modeled and analyzed, to aid in understanding the range of possible outcomes and preparing for different economic conditions.

The economic event simulation module 510 can utilize historical transaction data and past economic event patterns to add realism to the simulations. This historical context can ensure that the simulated scenarios are grounded in realistic and plausible economic behaviors.

By simulating various economic events, the economic event simulation module 510 can aid businesses and financial analysts in assessing risks and formulating strategic plans. The economic event simulation module 510 can provide valuable insights into how industries might be affected by different economic shocks, enabling proactive risk management and strategic decision-making.

The economic event simulation module 510 can include interactive features, allowing users to modify the parameters of the simulated events and observe the resulting impacts. This interactivity can enhance the utility of the economic event simulation module 510 as an analytical tool.

The data visualization module 512 within the network modeling engine 206 is a component designed to translate complex financial data and analytical insights into intuitive and easily interpretable visual formats. The data visualization module 512 enhances the usability and comprehensibility of the data derived from the network modeling engine, making it accessible to a wider range of users. Functions of the data visualization module 512 include creating interactive visual representations, dynamic visualization of temporal changes, illustrating the impact of economic events, customizable visualizations, enhancing interpretability with data layers, and facilitating communication and reporting.

One function of the data visualization module 512 is to generate visual representations of the network of industry dependencies. The data visualization module 512 can create interactive graphs, charts, and maps where each industry is represented as a node, and the dependencies are illustrated as links. These visuals can enable users to easily understand and explore the intricate relationships between different industries.

The data visualization module 512 can be capable of visualizing how industry dependencies evolve over time, reflecting the temporal analysis conducted by the temporal analysis module 506. Users can observe changes in dependency strengths across different time periods, providing insights into how industry relationships are affected by temporal factors.

In conjunction with the event tagging module 508 and the economic event simulation module 510, the data visualization module 512 can graphically display the impact of macroeconomic events on industry dependencies as an aid in understanding the before-and-after effects of such events on the financial network.

The data visualization module 512 can offer customizable visualization options, allowing users to tailor the visual output according to their specific needs and interests. Users can choose different parameters and filters to focus on particular aspects of the data.

The data visualization module 512 can layer additional data onto the visualizations, such as transaction volumes, values, or industry-specific information. This multi-layered approach enriches the visual representation, providing a more comprehensive view of the data.

By transforming complex data sets into clear and engaging visuals, the data visualization module 512 can aid in the communication of findings and insights. The data visualization module 512 can support the integrated reporting module 518 by providing visual aids that can be included in reports and presentations.

The cash flow projection module 514 within the network modeling engine 206 can serve a role in forecasting and analyzing the financial trajectory of customers over time. The cash flow projection module 514 is designed to model and project the future cash flows of customers, considering their interactions within the network of industry dependencies and the potential impacts of macroeconomic fluctuations. Functions of the cash flow projection module 514 include projecting future cash flows, incorporating industry dependencies, simulating macroeconomic impacts, temporal analysis, customize cash flow scenarios, risk assessment and management, and enhanced decision-making.

One function of the cash flow projection module 514 is to model and forecast the cash flow for customers based on current and historical transaction data. The cash flow projection module 514 can use patterns and trends identified in the data to predict future inflows and outflows of cash.

The cash flow projection module 514 can take into account the dependencies between industries as mapped in the network. The cash flow projection module 514 can analyze how these dependencies might affect a customer's cash flow, considering both direct and indirect financial relationships.

In conjunction with the economic event simulation module 510, the cash flow projection module 514 can assess how different simulated economic events might impact a customer's cash flow. This can include modeling scenarios such as economic downturns, policy changes, or market disruptions.

The cash flow projection module 514 can integrate temporal elements, allowing for the projection of cash flows across various future timeframes, which can be helpful for long-term financial planning and risk management.

The cash flow projection module 514 can offer customization options, enabling users to create and analyze different cash flow scenarios based on varying assumptions and parameters, enabling for a more tailored and detailed financial analysis.

By projecting future cash flows under different conditions and scenarios, the cash flow projection module 514 can aid in assessing and managing financial risks. The cash flow projection module 514 can help customers and financial analysts to identify potential cash flow challenges and opportunities. The insights provided by the cash flow projection module 514 can be helpful for strategic decision-making, as businesses can use these insights to make informed decisions about investments, expenditures, and financial strategies.

The customer exposure assessment module 516 within the network modeling engine 206 is a specialized component designed to evaluate and quantify the exposure of a customer to various risks associated with economic events and industry dependencies. The customer exposure assessment module 516 plays a role in identifying and assessing the potential impacts of external economic factors on a customer's financial position. Functions of the customer exposure assessment module 516 include assessing risk exposure, integrating industry dependency data, scenario-based exposure analysis, customized exposure profiles, supporting strategic decision-making, providing early warnings, and enhancing financial planning and risk management.

One function of the customer exposure assessment module 516 is to analyze how different macroeconomic events or changes in industry dependencies could affect a particular customer. The customer exposure assessment module 516 can consider various risk factors, such as market volatility, economic downturns, policy changes, or shifts in industry trends, to determine the customer's exposure to these risks.

The customer exposure assessment module 516 can utilize data from the network that represents industry dependencies to understand how changes in these dependencies might impact the customer. This can include examining both direct and indirect effects of industry interrelations on the customer's financial health.

The customer exposure assessment module 516 can allow for the modeling of different scenarios to assess how a customer would be impacted under various conditions. This can involve simulating different economic events and analyzing the consequent changes in the network of industry dependencies.

The customer exposure assessment module 516 can generate customized exposure profiles for individual customers. These profiles can take into account the specific characteristics and activities of the customer, providing a tailored risk assessment.

The insights provided by the customer exposure assessment module 516 can assist customers and financial analysts in making informed strategic decisions. By understanding the potential risks and exposures, customers can better plan for and mitigate these risks.

The customer exposure assessment module 516 can serve as an early warning system, alerting customers to potential risks and exposures based on current trends and forecasted economic conditions. This proactive approach enables customers to take preemptive actions to safeguard their financial positions. The customer exposure assessment module 516 can contribute to financial planning and risk management strategies by equipping customers with the necessary information to prepare for and navigate through various economic landscapes.

The integrated reporting module 518 within the network modeling engine 206 can be configured to consolidate and present the comprehensive analyses and insights generated by the engine in a coherent and accessible format. In particular, the integrated reporting module 518 can facilitate the communication of complex data and analytical results to users, aiding in decision-making processes. Functions of the integrated reporting module 518 include: compilation of analytical insights, customizable reporting, user-friendly presentation, interactive reporting features, automated report generation, integration with user interface, and export and distribution capabilities.

One function of the integrated reporting module 518 is to compile the insights and findings derived from various modules within the engine, including the network construction, dependency strength projection, temporal analysis, and customer exposure assessment. In embodiments, the integrated reporting module 518 can integrate these diverse pieces of information into a unified report.

The integrated reporting module 518 can offer customizable reporting capabilities, allowing users to tailor the content and format of the reports according to their specific needs and preferences. This customization can include selecting specific data points, analysis periods, economic scenarios, and industry focuses.

The integrated reporting module 518 can be designed to present the data and analysis in a user-friendly manner. The integrated reporting module 518 can use clear and intuitive formats, such as charts, graphs, and tables, making the information easily understandable for users with varying levels of expertise.

The integrated reporting module 518 can include interactive features in the reports, such as clickable elements or dynamic charts. These features can enable users to explore the data more deeply and interactively, providing a more engaging experience.

The integrated reporting module 518 can be configured to automatically generate reports at regular intervals or in response to specific triggers, such as significant economic events or notable changes in industry dependencies. This automation can ensure timely updates and reduces the manual effort required for report generation.

The integrated reporting module 518 can communicate with the user interface 208, ensuring seamless integration and accessibility of the reports through the system's interface. This integration can allow users to access and interact with the reports directly within the system. Additionally, the integrated reporting module 518 can include functionalities to export the reports in various formats (e.g., PDF, Word, Excel) and distribute them to different stakeholders, to facilitate the sharing of insights and findings with relevant parties both within and outside the organization.

In some embodiments, the integrated reporting module 518 can incorporate advanced AI capabilities, particularly leveraging machine learning and natural language processing (NLP), to improve user interaction and report generation. This AI integration enhances user-friendliness by allowing users to interact with the system through verbal or short text descriptions, moving away from traditional fixed interfaces.

Utilizing NLP, the integrated reporting module 518 can interpret and process user queries presented in natural language. For instance, a user in the paper manufacturing industry could input a query like, “How will a rise in interest rates over the next year affect my cash flow?” The NLP component analyzes this input, extracting key information such as the industry type, the specific economic factor of interest (rise in interest rates), and the time frame (next year).

Once the query is processed, machine learning algorithms within the integrated reporting module 518 use this information to contextualize the user's needs. The algorithms can reference historical data, industry-specific trends, and previous similar queries to understand the query's intent and required output fully, enabling the system 100 to tailor the report specifically to the user's requirements.

In some embodiments, the system 100 can be programmed to generate reports based on specific triggers, such as a notable change in interest rates or other economic indicators. Alternatively, users can set the module to run reports on a periodic basis, ensuring regular updates on key financial metrics and trends.

The AI in the integrated reporting module 518 can learn from each interaction, improving its understanding of user queries and refining the accuracy of report generation over time. This iterative learning process ensures that the system becomes more attuned to the specific needs and preferences of its users.

Additionally, the ability to process natural language queries minimizes the need for users to understand complex data input methods. This makes the system 100 accessible to a broader range of users, regardless of their technical expertise.

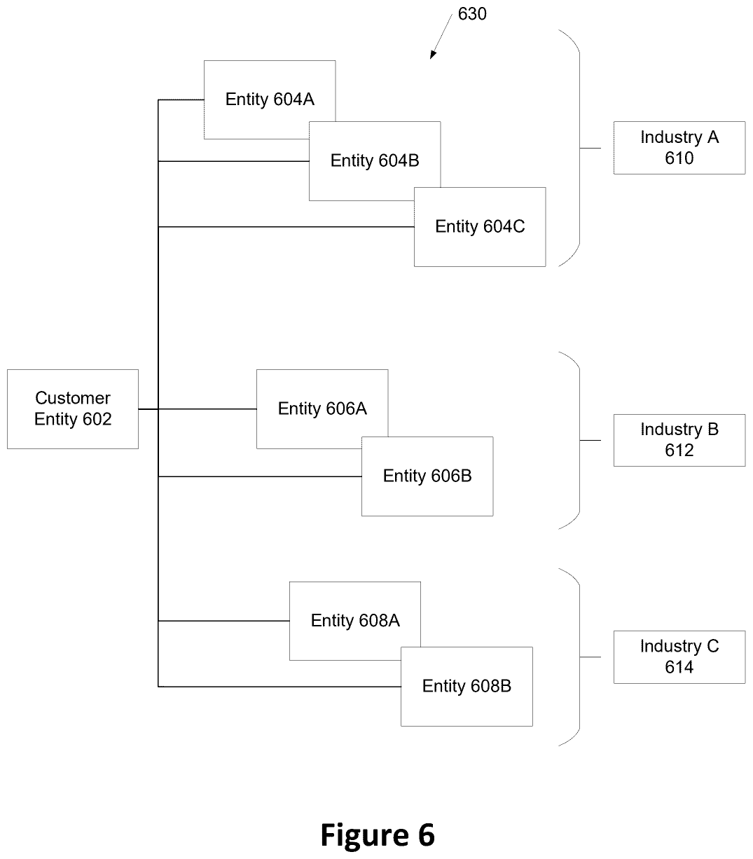

With additional reference to FIG. 6, a transaction-based connection model 630 between a customer and a plurality of entities organized into industries is depicted. In some embodiments, the transaction-based connection model 630 can be developed by the network modeling engine 206, and can be displayed on the user interface 208 offering a visual depiction of financial interactions and dependencies. Alternatively, the transaction-based connection model 630 can be presented in a variety of alternative reporting formats, accommodating user-specific needs and scenarios. In embodiments, the reporting formats can include real-time alerts and notifications for immediate updates, detailed PDF reports for in-depth analysis, and direct email communication for efficient information dissemination.

In this example, the customer entity 602 is engaged in the manufacture of an array of paper products, including but not limited to boxes, folding cartons, plates, cups, napkins, and miscellaneous paper products. The product range classifies the customer entity 602 under both the paperboard container manufacturing and all other paper product manufacturing industries.

The business operations of the customer entity 602 involve selling its manufactured paper products to various entities, denoted as 604A, 604B, and 604C, belonging to the food and beverage industry 610, indicating a commercial relationship where the paper products find utility in food packaging and service.

For the production of these paper products, the customer entity 602 sources its primary raw material, wood pulp, from businesses 606A and 606B, which are part of the pulp mill industry 612. This procurement represents a supply chain link, essential for the manufacturing process of the customer entity 602.

Additionally, the operational requirements of the customer entity 602 extend to human resources, for which it contracts with businesses 608A and 608B, operating within the employment placement agency industry 614. These contracts facilitate the acquisition of labor, critical for the customer entity's 602 manufacturing and operational processes.

The transactional dynamics between these entities are recorded within the system 100. Each transaction is documented as a double entry, encapsulating the dual nature of every financial exchange—as an outflow for one entity and a corresponding inflow for another. This dual-entry system enables the system 100 to comprehensively summarize the cash flows between industries, either as a monetary value or a quantity of transactions over a specified time period. Notably, these summarized cash flows can elucidate the general movement of cash from one industry to another.

To extend the applicability and accuracy of these insights, the system 100 implements this process across a large spectrum of businesses. By aggregating the cash flows between industries, the system effectively minimizes anomalies and noise that could be specific to individual business entities.

In some embodiments, statistical methodologies are employed to ensure a representative and equitable aggregation of data. This can involve ensuring that the number of business entities included in the aggregation provides an accurate reflection of each industry, with equal weighting assigned across industries. In some embodiments, the aggregated industry cash flows are structured to be representative of a minimum sampling size, thereby providing a reliable and statistically significant overview of the business activities within each industry.

The aggregation of industry cash flows can be utilized to construct a network model 632, as exemplified in FIG. 7, which can serve as a visual representation of the financial relationships existing between various industries. In embodiments, the network model 632 can be constructed by the network modeling engine 206, and displayed on the user interface 208. Alternatively, the network model 632 can be presented in a variety of other reporting formats to accommodate user-specific needs and scenarios. In embodiments, the reporting formats can include real-time alerts and notifications for immediate updates, detailed PDF reports for in-depth analysis, and direct email communication for efficient information dissemination.

In this network model 632, the customer entity 602 is prominently featured as a first node interconnected with a multitude of other nodes, each symbolizing different industries, specifically industries 610, 612, 614, 616, 618, 620, 622, and 624. These nodes collectively represent the expansive and diverse commercial interactions of the customer entity 602 across various sectors.

One aspect of this network model 632 is the visualization of cash flows between industries. These financial exchanges are depicted as links 630 connecting the various industry nodes. To convey the magnitude of cash flow between two industries effectively, each link 630 is characterized by distinct visual attributes, such as varying thicknesses or colors. For instance, a thicker link may indicate a larger volume of cash flow between two connected industries, while a thinner link suggests a lesser magnitude. Similarly, different colors can be employed to represent various attributes of the cash flows, such as frequency, value, or type of transactions.

Another feature of the network model 632 is its incorporation of a temporal dimension. This dynamic aspect allows for the visualization of cash flows to evolve over time. As such, the links 630 between industry nodes are not static but can change in accordance with the temporal fluctuations in cash flow. For example, a link 630 may become thicker or change color over time, reflecting an increase in transaction volume or value between the connected industries over a specified period.

This temporal dimension in the network model 632 provides a comprehensive and evolving view of the financial interdependencies among industries, offering valuable insights into how these relationships develop and transform over time. The network model 632 thereby becomes a powerful tool for analyzing market trends, forecasting industry dynamics, and informing strategic financial decisions.

Elaborating on the temporal dimension, in one embodiment, the network model 632 can include a slider bar interface, enabling users to interactively scroll along an established timeline in order to visually represent changes in cash flows and industry dependencies at various points over time, offering a user-friendly means to traverse historical data and observe financial trends. Alternatively, the network model 632 can prompt users to input a specific start date and end date, enabling a focused analysis of the changes in financial interdependencies within the selected date range, allowing for a targeted examination of how industry relationships have strengthened or weakened during the specified period, providing customized insights based on user-defined temporal parameters. Both implementations of the temporal dimension enhance the model's utility, allowing for a tailored and interactive exploration of financial data over time.

In the described embodiment, the system 100 can be utilized by a customer entity 602 engaged in paper manufacturing to simulate and analyze the impact of a rise in interest rates over the forthcoming year on their cash flow. This analysis can be facilitated through the creation of a network model 632 within the system 100, which is designed to accurately reflect the financial dynamics under varying economic conditions.

To construct this network model 632, the system 100 leverages historical transaction data, particularly focusing on periods before and after previous instances of rising interest rates. This historical data serves as a foundation for establishing the patterns of cash flows between industries during similar economic shifts. By analyzing multiple instances of interest rate changes, the system can aggregate and correlate the corresponding cash flows, thereby enhancing the accuracy and relevance of the model.

Once the general model reflecting industry-wide cash flows during interest rate fluctuations is established, the system then incorporates specific details pertaining to the customer entity 602. This customization ensures that the resulting model is precisely tailored to reflect the unique financial position and operations of the customer entity 602, thereby providing more targeted and applicable insights.

In this scenario, the model is capable of visually representing the dual impact of rising interest rates on the customer entity 602. It illustrates how an increase in interest rates might lead to a decrease in the costs of wood pulp and labor—essential inputs in paper manufacturing—thus benefitting the entity. Simultaneously, the model also projects the potential decrease in cash inflows from the sales of paper products, a common consequence of tighter monetary conditions impacting customer spending. This dual visualization aids in comprehending the nuanced financial effects of the economic shift.

Further, the model has the capability to highlight potential risks to the customer entity 602. For instance, it can identify scenarios where the reduction in cash inflows significantly outweighs the savings on outflows, indicating a potential cash flow challenge.

In certain embodiments, the system 100 can automatically execute various scenarios to assess the customer entity 602 for different financial risks. This includes setting up triggers based on specific risk indicators, such as a projected negative cash flow. Upon identifying such risks, the system can generate and provide notifications, thereby offering proactive alerts to potential financial challenges. This feature enables the customer entity 602 to take timely and informed decisions to mitigate risks and manage their financial health effectively in the face of changing economic conditions.

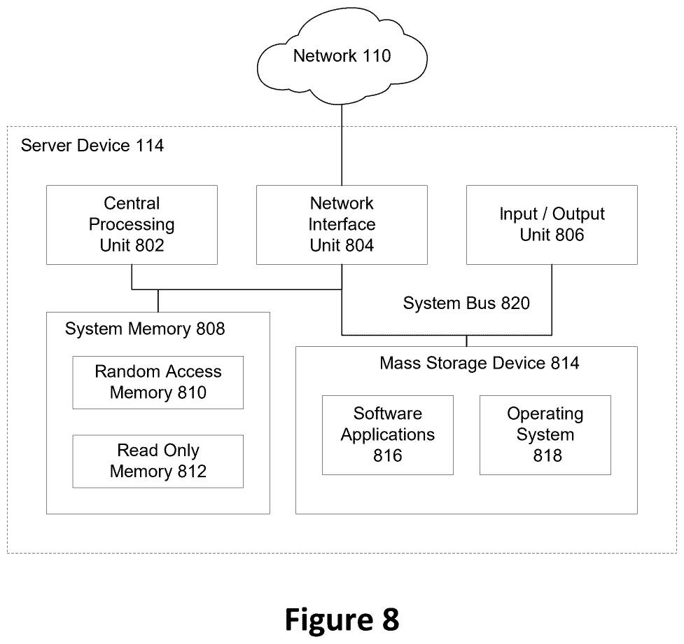

As illustrated in the embodiment of FIG. 8, the example server device 114, which provides the functionality described herein, can include at least one central processing unit (“CPU”) 602, a system memory 808, and a system bus 820 that couples the system memory 808 to the CPU 802. The system memory 808 includes a random access memory (“RAM”) 610 and a read-only memory (“ROM”) 612. A basic input/output system containing the basic routines that help transfer information between elements within the financial analytics system 100, such as during startup, is stored in the ROM 812. The financial analytics system 100 further includes a mass storage device 814. The mass storage device 814 can store software instructions and data. A central processing unit, system memory, and mass storage device similar to that shown can also be included in the other computing devices disclosed herein.

The mass storage device 814 is connected to the CPU 802 through a mass storage controller (not shown) connected to the system bus 820. The mass storage device 814 and its associated computer-readable data storage media provide non-volatile, non-transitory storage for the financial analytics system 100. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the financial analytics system 100.

According to various embodiments of the invention, the financial analytics system 100 may operate in a networked environment using logical connections to remote network devices through network 620, such as a wireless network, the Internet, or another type of network. The network 620 provides a wired and/or wireless connection. In some examples, the network 620 can be a local area network, a wide area network, the Internet, or a mixture thereof. Many different communication protocols can be used.

The financial analytics system 100 may connect to network 620 through a network interface unit 804 connected to the system bus 820. It should be appreciated that the network interface unit 804 may also be utilized to connect to other types of networks and remote computing systems. The financial analytics system 100 also includes an input/output controller 806 for receiving and processing input from a number of other devices, including a touch user interface display screen or another type of input device. Similarly, the input/output controller 806 may provide output to a touch user interface display screen or other output devices.

As mentioned briefly above, the mass storage device 814 and the RAM 810 of the financial analytics system 100 can store software instructions and data. The software instructions include an operating system 818 suitable for controlling the operation of the financial analytics system 100. The mass storage device 814 and/or the RAM 810 also store software instructions and applications 816, that when executed by the CPU 802, cause the financial analytics system 100 to provide the functionality of the financial analytics system 100 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A method for forecasting an impact of macroeconomic fluctuations on interdependencies among industries, the method comprising:
acquiring payment transaction data from a plurality of banking customers, wherein the payment transaction data includes an industry classification of the originating party, an industry classification of one or more receiving parties, and amounts of the payment transactions;
aggregating the payment transaction data by industry to establish dependencies between the industry classification of the originating party and the industry classification of one or more receiving parties, wherein the dependencies are based on an aggregated total of the amounts of the payment transactions occurring between the originating party and the one or more receiving parties over a period of time;
establishing a network model to represent the dependencies between the two or more industries, wherein each industry is denoted as a node in the network model, and the dependencies between the nodes are denoted as links, with a characteristic of each link indicating a strength of the dependencies between the two or more industries; and
adding a temporal element to the network model, enabling a customer to observe a relative change in the strength of the dependencies between the two or more industries relative to macroeconomic fluctuations.

2. The method of claim 1, further comprising modeling a cash flow over time for the customer, based at least in part, on the strength of the dependencies between the two or more industries and a simulated change in a currency value.

3. The method of claim 1, further comprising tagging first payment transaction data occurring during a first period before a macroeconomic event, and tagging second payment transaction data occurring during a second period after the macroeconomic event to observe before and after effects of the macroeconomic event on the strength of the dependencies between the two or more industries.

4. The method of claim 3, further comprising modeling a projected strength of a dependency between the customer and an industry, based at least in part, on the observed before and after effects of the macroeconomic event on the strength of the dependencies between the two or more industries.

5. The method of claim 4, further comprising comparing actual customer transactions against the projected strength of the dependency between the customer and the industry to assess an exposure of the customer to a simulated economic event.

6. The method of claim 4, further comprising modeling a projected cash flow over time for the customer, based at least in part, on the observed before and after effects of the macroeconomic event on the strength of the dependencies between the two or more industries.

7. The method of claim 3, wherein the macroeconomic event represents a change in at least one of a plurality of variable metrics tracked by the network model.

8. The method of claim 7, wherein the plurality of variable metrics tracked by the network model include a change in at least one of a currency value, an interest rate, inflation rate, import duties, export duties, gross domestic product, unemployment rate, manufacturing output, and consumer spending.

9. The method of claim 8, further comprising utilizing a statistical model to isolate before and after effects of one variable metric of the plurality of variable metrics tracked by the network model.

10. The method of claim 1, wherein the industry classification of the originating party and the industry classification of the receiving party are based on the North American Industry Classification System (NAICS).

11. A computer system for forecasting an impact of macroeconomic fluctuations on interdependencies among industries, comprising:
one or more processors; and
non-transitory computer readable storage media encoding instructions which, when executed by the one or more processors, causes the computer system to:
acquire payment transaction data from a plurality of banking customers, wherein the payment transaction data includes an industry classification of the originating party, an industry classification of one or more receiving parties, and amounts of the payment transactions;
aggregate the payment transaction data by industry to establish dependencies between the industry classification of the originating party and the industry classification of one or more receiving parties, wherein the dependencies are based on an aggregated total of the amounts of the payment transactions occurring between the originating party and the one or more receiving parties over a period of time;
establish a network model to represent the dependencies between the two or more industries, wherein each industry is denoted as a node in the network model, and the dependencies between the nodes are denoted as links, with a characteristic of each link indicating a strength of the dependencies between the two or more industries; and
add a temporal element to the network model, enabling a customer to observe a relative change in the strength of the dependencies between the two or more industries relative to macroeconomic fluctuations.

12. The system of claim 11, wherein the computer system is further configured to model a cash flow over time for the customer, based at least in part, on the strength of the dependencies between the two or more industries and a simulated change in a currency value.

13. The system of claim 11, wherein the computer system is further configured to tag first payment transaction data occurring during a first period before a macroeconomic event, and tag second payment transaction data occurring during a second period after the macroeconomic event to observe before and after effects of the macroeconomic event on the strength of the dependencies between the two or more industries.

14. The system of claim 13, wherein the computer system is further configured to model a projected strength of a dependency between the customer and an industry, based at least in part, on the observed before and after effects of the macroeconomic event on the strength of the dependencies between the two or more industries.

15. The system of claim 14, wherein the computer system is further configured to compare actual customer transactions against the projected strength of the dependency between the customer and the industry to assess an exposure of the customer to a simulated economic event.

16. The system of claim 14, wherein the computer system is further configured to model a projected cash flow over time for the customer, based at least in part, on the observed before and after effects of the macroeconomic event on the strength of the dependencies between the two or more industries.

17. The system of claim 13, wherein the macroeconomic event represents a change in at least one of a plurality of variable metrics tracked by the network model.

18. The system of claim 17, wherein the plurality of variable metrics tracked by the network model include a change in at least one of a currency value, an interest rate, inflation rate, import duties, export duties, gross domestic product, unemployment rate, manufacturing output, and consumer spending.

19. The system of claim 18, wherein the computer system is further configured to create a statistical model to isolate before and after effects of one variable metric of the plurality of variable metrics tracked by the network model.

20. The system of claim 11, wherein the industry classification of the originating party and the industry classification of the receiving party are based on the North American Industry Classification System (NAICS).
